(19) United States
(12) Patent Application Publication
(10) Pub. No.: US 2007/0176766 A1
(43) Pub. Date: Aug. 2, 2007

(54) Remote controlled smoke alarm with timer

(76) Inventor: Yoko Cheng, Great Neck, NY (US)

Correspondence Address: MOONRAY KOJIMA, BOX 627, WILLIAMSTOWN, MA, 01267, US

(21) Appl. No.: 11/344,700

(22) Filed: Feb. 1, 2006

(51) Int. Cl. G08B 23/00

(52) U.S. Cl. 340/527

(57) ABSTRACT

A smoke detector system wherein a smoke alarm which is turned “on” by the sensing of smoke is turned “off” for a predetermined period of time using a disable signal transmitted by a remote controller and an indicator light is turned “on” to indicate that the alarm is turned “off”, and wherein after the predetermined period of time, the alarm is returned to a normal state and the indicator light is turned off. Thus, when the smoke detector alarm is turned “on” by an erroneous or non-lethal sensing of smoke, a housekeeper can readily turn “off” the alarm for the predetermined period of time and see by the indicator light that the alarm is off for that period of time. Advantageously, the remote controller comprises a container having a permanent magnet and the remote controller is physically apart from the detector so that the controller can be conveniently stored, for example on a refrigerator door for quick use and storage.

### BACKGROUND OF THE INVENTION

1. Field of Invention

This invention relates to smoke detectors and more particularly, to a remote controlled smoke detector with a timer.

2. Description of the Prior Art

The ordinary household smoke detector is plagued by various problems, one of which is the turning on of the alarm by smoke caused by ordinary cooking. This is very annoying since most detectors emit a piercing sound which can upset an ordinary person's nerves. After a few such false alarms, the housekeeper may be tempted to remove the battery or otherwise permanently disconnect the smoke detector. Accordingly, when a real fire occurs, the smoke detector may be disconnected and inoperable and great damage may occur to property and persons. But, often because the smoke detector is usually located in the ceiling, rather than disconnect the power source, the noise affected housekeeper may be tempted to destroy the smoke detector, such as by using a broom stick, or other instrument.

There are many instances of the prior art showing smoke detectors for remotely turning off such smoke detectors. Examples are U.S. Pat. No. 4,788,530; U.S. Pat. No. 6,172,612; U.S. Pat. No. 6,642,849; U.S. Pat. No. 4,600,314 and U.S. Pat. No. 5,442,336.

U.S. Pat. No. 4,788,530 discloses a switching device which is located a distance away, such as on a wall, from a smoke detector located in the ceiling which can be manually operated to disconnect the smoke detector from a battery located in the switching device used to power the smoke detector. After a predetermined period of time, a time delay circuit causes the disconnected smoke detector to be normally connected to the smoke detector. Disadvantageously, the switching device is physically connected to the alarm. Thus, a housekeeper must travel to the location of the switching device in order to disable a false alarm.

U.S. Pat. No. 6,172,612; U.S. Pat. No. 4,788,530 and U.S. Pat. No. 6,642,849 are similar to each other and have similar problems. U.S. Pat. No. 4,600,314 discloses a smoke detector and remote controller for temporarily shutting off the detector and a timer for returning power to the detector after a set period, wherein a battery coupling mechanism allows the detector battery to be mounted in the remote controller. But, the remote controller is physically connected to the controller and hence has similar problems. U.S. Pat. No. 5,442,336 employes a wireless radio frequency signal to temporarily turn off a smoke detector. But, this disclosure lacks simplicity and handiness of a consumer oriented device.

Thus, accordingly, in the related art there is lacking a smoke detector system which can be readily, easily and handily temporarily turned off by the housekeeper when a false alarm is triggered.

### SUMMARY OF THE INVENTION

An object of the invention is to overcome the aforementioned and other problems and deficiencies of the prior art.

A further object is to provide a remote controller which is physically unconnected to one or more smoke detector for disabling the one or more smoke detectors so that any inadvertent or false alarms emitted by the one or more detectors can be temporarily turned off for a predetermined duration of time after which the one or more detectors will return to a normal mode.

Another object is to provide a remote controller which is compact, handy, and simple and can be stored at a handy location for ready access by the housekeeper that desires to temporarily disable the inadvertent alarm emitted from the smoke detector.

The foregoing and other objects are attained by the invention which encompasses in combination at least one smoke detector unit and a remote controller unit which is physically unconnected, such as by a wire, to the smoke detector, and controls the smoke detector using a signal transmitted by the remote controller and received by the smoke detector.

The smoke detector comprises an alarm, a power source, a sensor for detecting smoke or other factors and in response thereto causing the alarm to operate, and a receiver circuit for receiving a disable signal from the remote controller unit when it is desired to cause temporary shutting off of the alarm which may have been inadvertly or falsely triggered by smoke. The receiver circuit is connected to the alarm and power source to cause the alarm to be disabled. Also, provided in the smoke detector unit is a timer circuit which is operable by the receiver circuit when the receiver circuit receives the disable signal, so as to cause the alarm and sensor to be turned off for a predetermined period of time after the alarm is disabled. When the period of time expires, the smoke detector unit and its components are all returned to a normal mode ready for the sensor to again sense smoke or other factors and the alarm ready to be triggered to operate in response to such smoke or other factor. In addition, the smoke detector unit comprises an indicator light which is turned on when the disable signal is received by the receiver circuit, and is turned off when the predetermined period of time expires and the smoke detector unit is returned to normal mode.

The remote controller unit comprises a disable signal generator, an amplifier, an antenna, a power source to power the signal generator and amplifier, and a switching means, such as operated operated by a push button. When the house keeper pushes the button, the power source is applied to the signal generator to generate a disable signal which is transmitted by the antenna and received by the receiver of the smoke detector unit. Advantageously, the remote controller unit is contained in a compact, handy and simple container having a part of the outer surface thereof made of a magnetic material. Thus, the controller unit can be stored, for example, on the surface of a refrigerator, where a user can readily find such unit and use when needed, to turn off an alarm inadvertently or undesirably turned on.

A feature is the use of a remote controller unconnected to a smoke detector to disable a smoke alarm for a predetermined period and use of a disable signal generated by the remote controller and received by the smoke alarm to disable the smoke alarm for a predetermined period.

Another feature is the use of a signal generator to generate a disable signal which is transmitted from the remote controller and received by the smoke detector to cause the alarm of the smoke detector to be disabled for a predetermined period of time.

A further feature is the returning to normal mode of operation of the smoke detector after end of the predetermined period to time of disablement.

Another feature is the use of a push button in a remote controller to start signal generation, which signal is then transmitted from the remote controller to the smoke detector to cause the alarm thereof to be disabled for a certain duration of time.

A further feature is the use of a permanent magnet on a container for the remote controller so as to enable the container to be handily positioned, such as on a refrigerator, for ready and simple use and storage.

A yet further feature is to use in the smoke detector of a signal receiver which causes a switching means to disconnect the power source from the alarm and thus cause the smoke detector to become disabled for a certain period of time.

Another feature is the use in the smoke detector of a timer in combination with the signal receiver so that after disablement the timer will automatically cause the alarm to be disabled for a predetermined period of time, such as 20 minutes, after which the smoke detector and alarm will be returned to normal mode of operation where the alarm is off and awaiting the sensor to sense smoke or other factor.

A further feature is the use of an indicator light in the smoke detector which is turned on when the smoke detector alarm is turned off by the disable signal being, transmitted from the remote controller and received by the receiver circuit in the smoke detector, and then turned off at the expiration of the predetermined duration of time that the alarm is turned off.

Another feature is the combination of the above features in a smoke detector system.

Another feature is that the disable signal transmitted from the remote controller is selected from the group consisting of ultra-sound, infra-red and high frequency waves.

A further feature is that the remote controller is used solely to disable the alarm of the smoke alarm.

Another features is the changing of the duration of time which the alarm is disabled, with a preferred duration being 20 minutes.

Another feature is the use of a push-button to actuate the disabling of the alarm of the smoke detector.

A further feature is that the remote control unit comprises a signal generator for emitting the disable signal, an amplifier, an internal antenna, and an energy source.

Another feature is the use of a plurality of alarm units and the use of one or more remote controller units to disable selected ones of the plurality of alarms.

A further feature is the use of at least one alarm unit comprising a sensor, an alarm device, a timer, a signal receiver and a power source.

A further feature is a timer comprising a capacitor and a resistor connected across two terminals of an integrated circuit unit.

Another feature is the use of infra-red di able signals transmitted from a remote controller and received by a receiver circuit of a smoke detector so as to cause the alarm thereof to be disabled.

A further feature is the use of the disable signal to cause disabling of the alarm of the smoke detector and the concurrent start of a timer to control the duration of time the alarm is in a disabled state and furthermore to concurrently turn on an indicator light which is then automatically turned off when the alarm is no longer in a disabled state.

### BRIEF DESCRIPTION OF THE DRAWING

FIG. 1 is a block diagram of the smoke detector system of the invention comprising the smoke detector and used therewith a remote controller.

FIG. 2 is a more detailed circuit diagram of the smoke detector of FIG. 1 FIG. 3 is a side elevation view of the remote controller unit showing the push button and the magnet attached thereto.

### DETAILED DESCRIPTION OF INVENTION

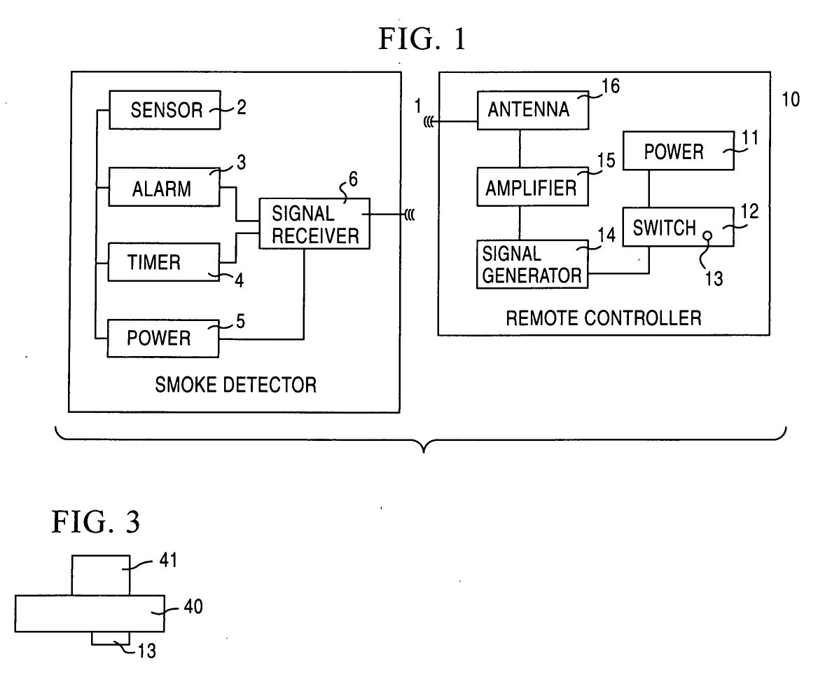

FIG. 1 depicts in block diagram form a detection system comprising a smoke detector 1 and a remote controller 10 and the components thereof working in combination to turn off an inadvertently turned on alarm and to keep the alarm off for a predetermined period of time and then to return the detector to a normal non-alarm state.

The smoke detector 1 and remote controller 10 together have the following modes of operation: MODE 1, smoke detector 1 and remote controller 10 not operated because of no smoke in the environment. MODE 2. smoke detector 1 has alarm operating due to smoke in the environment. MODE 3. Remote controller 10 operated with push button actuated and a disable signal generated and transmitted to detector 1. Detector 1 receives disable signal and causes the alarm of smoke detector 1 to be disabled and a timer is actuated to start disabling for predetermined duration of time and to cause an indicator light to be turned on. MODE 4. After predetermined time, such as 20 minutes, the timer in the smoke detector 1 causes the alarm to be returned to MODE 1 with the alarm off, the indicator light off.

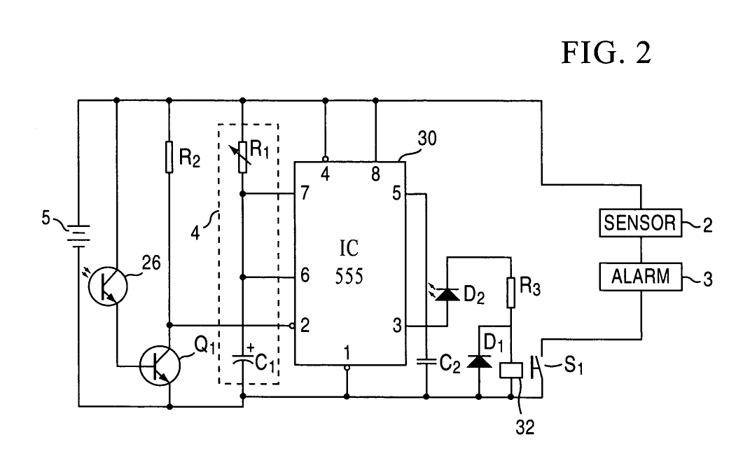

The smoke detector 1 comprises a sensor 2, alarm 3, timer 4, power source 5 and a receiver 6. The sensor 2 may be any known sensor which, for example, detects smoke. The alarm 3 may comprise any known circuit for turning on an alarm and turning off such alarm. Also, in such alarm circuit, there may be an indicator light, such as shown in FIG. 2. Timer 4 may comprise any known timing circuit which can be adjusted for the duration desired such as 20 minutes, for which the alarm 3 is turned off and the indicator light is turned on. Power source 5 may be an ordinary line power or a battery as desired. It is used to power the sensor 2, alarm circuit 3, timer 4 and signal receiver 6. The signal receiver 6 is used to receive a disable signal which is transmitted by antenna 16 of the remote controller 10, and the causes the timer 4 and alarm circuit 3 and alarm thereof to operate so that first, the alarm, which is turned on by detection of smoke by sensor 2, is turned off, the timer is turned on so that the duration of time the alarm is turned off will be controlled by timer 4, and the indicator light (see FIG. 2, item D2) will be turned on. Advantageously, the disable signal may be an ultrasound, infrared, or high frequency waves. In that case, the receiver circuit 6 is any known circuit to receive such type of signal.

The remote controller comprises a power source 11, such as a battery, a switching circuit 12 which may utilize a push button 13 for manual actuation, a signal generator 14 which generates the disable signal, which is then amplified by amplifier 15 and transmitted by antenna 16 to the signal receiver 6 of the smoke detector 1. The power source 11 supplies power to the switch 12, signal generator 15, amplifier 15 and antenna 16. The antenna 16 and amplifier 15 may be any known circuitry. The signal generator 14 generates the appropriate disable signal, such as ultrasound infrared, or high frequency wave, as desired. The circuitry for the signal generator are well known and can be selected as desired. However, the circuitry is preferred to be enclosed in a container, such as shown in FIG.3, wherein the container 40 has a push button 13, and as a part thereof one of the surfaces has a permanent magnet thereon 41.

The permanent magnet which forms part of the surface of the container for the remote controller 10, is a part of the invention and provides certain advantageous properties to the invention. The house keeper often stores notes, etc on a refrigerator door because of its handy location and because the refrigerator forms a central location in the kitchen work place. The permanent magnet 41 surface enables the remote controller 10 contained in the container 40 to be placed and held by magnetic force on the door of the refrigerator for easy access, easy viewing, and handy, quick actuation of the stopping of the smoke alarm. Thus, when the smoke detector alarm is caused to be on when smoke from ordinary cooking caused the alarm to be on, the housekeeper may quickly and easily grab the remote controller 10, push the button, and stop the alarm. Then, the house keeper can then easily and effortlessly place the controller container against the door so that the magnet 41 holds by magnetic force the controller 10 against the refrigerator door.

Advantageously, the remote controller 10 is unconnected to the smoke detector 1 so that the controller can be conveniently placed anywhere it is in easy reach of the consumer.

Advantageously, although only one remote controller unit 10 is shown together with only one smoke detector 1, any plurality of or one of each can be used together with one or a plurality of the other.

To summarize briefly the foregoing, when the alarm in alarm unit 3 is turned on by sensor 2 detecting smoke or other factor with power supplied by power source 5, and such alarm is desired by the house keeper to be turned off, the housekeeper takes the remote controller 10 and pushes push button 13 to cause a disable signal to be generated by signal generator 14, amplified by amplifier 15, and transmitted by antenna 16 through the air to be received by signal receiver 6 of smoke detector l,which then causes timer 4 to start timing and the alarm of alarm circuit 3 to be turned off. In this manner, the alarm is turned off for the duration desired and set by timer 4, and also, an indicator light is turned on for the same time duration. At the end of the time duration, the alarm is again returned to a normal mode of operation, and the indicator light turned off. In the meantime, the house keeper had placed the remote controller back, for example, on the refrigerator door for next use.

Turning to FIG. 2 added details of the circuitry of the smoke detector 1 are shown, wherein a signal receiver 26 receives a disable signal sent from the antenna 16 of remote controller 10 and causes relay winding 32 and switch S1 to be activated to open the normally closed armature to open the circuit from battery 5 sensor 2 and alarm 3, so that the operated state of alarm 3 will be extinguished. This occurs when alarm 3 is inadvertently or otherwise undesired ringing of alarm 3 occurs, such as when sensor 2 sense smoke and causes alarm 3 to ring even though the smoke is from an ordinary steaming of a frying pan,etc., and the user or house keeper desires to shut off the unwanted alarm ringing for a predetermined time, such as until the frying is completed. It has been found that a 20 minute interval is convenient.

When push button 13 of controller 10 is pushed, power from source 5 is applied to signal generator 14 which generate an appropriate disable signal which is then amplified by amplifier 15 and transmitted through antenna 16 into the ether to be received by signal receiver 6 of smoke detector 1. In the embodiment shown, the disable signal is received by receiver 26 (of FIG. 2) and amplified by transistor Q1 and resistor R2 and applied to IC unit 30 terminals 1,2,4 and 8, as depicted. This causes the IC 30 to cause the LED (light emitter diode) D2 to emit light, and causes winding 32 to be energized and cause switch S1 to open the circuit for alarm 3 and battery 5. In this manner, the alarm 3 is disabled.

Concurrently, timer circuit 4 comprising resistor R1 and capacitor C1 which are connected to terminals 4,7,8 and 1 of IC 30 determine the duration that switch S1 will be in an open state. A preferred duration is 20 minutes although other durations can be used.

As depicted in FIG. 2, an IC 555 (integrated circuit) is provided with circuitry to provide the foregoing functions. Terminal 2 of IC 30 is connected between transistor Q1 and resistor R1 and forms the amplifier circuit. Terminal 3 is connected to LED D2 which is used to show that the alarm is disconnected or disabled. After the time duration for disconnect of the alarm is over, the LED D2 is extinguished. Thus, a person looking at the smoke detector 1 can see that the smoke detector alarm is in a disconnect stage when the light indicator is on and that the smoke detector is in a normal condition when the light indicator 30 is off. Moreover, terminal 3 is connected after D2 to resistor R3 to one side of relay winding 32, while the other side of relay winding 32 is connected to the negative terminal of battery 5. Terminal 2 of IC 30 is the trigger terminal for a transistor switch in IC 30 whereby a negative pulse is imparted at terminal 2,closes the relay winding circuit through battery 5, terminal 8,3 and then LED D2, resistor R3, winding 32 to battery 5.

A resistor P1 is connected to terminals 4,7 of chip 30 while a capacitor C1 is connected between terminals 6 and 1 of chip 30 thereby providing a time delay circuit 4, the duration of which time delay is determined by the respective values of R1 and C1, whereby the connection between terminals 1 and 8 opens after the time delay, e.g. 20 minutes. Upon opening of the circuit between terminals 8 and 1 of chip 30, relay winding 32 is deenergized and the switch blade S1 returns to an original closed position. Note in FIG. 2 the blade is shown as being in an open position. It is normally closed and energization of the winding causes the opening of the circuit when blade S1 is pulled toward the winding 32. As discussed, after 20 minutes, the smoke detector is returned to to MODE 1, that is its normal operation condition without the alarm ringing and waiting for the sensor to sense smoke which would then cause the alarm to ring. The LED D2 is turned off after the duration, such as 20 minutes.

A diode D1 is connected across relay winding 32 to reduce any voltage surge produced by relay winding 32 upon de-energization. A resistor R3 and capacitor C2 are connected as shown and serve to generate the pulse which triggers the time delay. The various components have the following preferred values, other values can be used as desired: R1=5M ohms; R2=100 K ohms. C1=300 microfarad; C2=0.01 microfarad.

Advantageously, the remote controller circuitry and the receiver circuitry of the smoke detector can be any of priorly known circuit which perform similar functions. For example, the controller circuitry maybe similar to the controller wand to turn on and off a television set,and the receiver circuitry may be the corresponding receiver circuit in the TV set.

What is claimed is:

1. An alarm system which emits a warning sound upon detection of an undesired factor in the environment, said system comprising in combination:
an alarm means comprising at least one alarm unit having an alarm, energizing means for powering said alarm, sensor means for detecting said undesired factor and for causing said alarm to operate, switching means for causing disabling of said energizing means from powering said alarm, and timer means for causing said switching means to reconnect said energizing means to said alarm after a preset duration of time, and an indicator means operable when said alarm is disabled and being turned off when said alarm is returned to a normal mode; and
remote control means which is physically unconnected to said alarm means for emitting a disable signal which is received by said switching means in said alarm means to cause disabling of said alarm and to cause operation of said timer means in said alarm means and concurrent operation of said indicator means.

2. The system of claim 1, wherein said control means comprises a container with at least a surface part thereof being made of a magnetic material.

3. The system of claim 1, wherein said signal sent from said remote control unit is selected from the group consisting of ultra-sound, infra-red and high frequency waves.

4. The system of claim 1, wherein said remote control unit is used solely to disable said alarm unit from operating.

5. The system of claim 1, wherein said timing device of said alarm means causes said alarm to be silenced by said disable signal from said remote control unit and to remain silenced for a preset duration of time, said preset duration of time being changeable.

6. The system of claim 5, wherein said duration of time is 20 minutes.

7. The system of claim 1, wherein said disable signal emitted by said remote control unit is triggered by manual operation of a push button connected to said switching means.

8. The system of claim 1, wherein said remote control unit comprises a signal generator for emitting said disable signal, an amplifier, an internal antenna, and an energy sources.

9. The system of claim 1, wherein said alarm unit comprises a plurality of alarms with which are controlled by a single common remote control unit which is unconnected to any of said plurality of alarms.

10. The system of claim 1, wherein said at least one alarm unit comprises a sensor, an alarm device, a timer, a signal receiver and a power source.

11. The system of claim 10, wherein said timer comprises a capacitor and a resistor connected across two terminals of an integrated circuit unit.

12. The system of claim 11, wherein said signal receiver comprises an infra-red or other wave induced unit which is triggered by said disable signal from said remote control unit.

13. The system of claim 12, wherein upon receipt of a disable signal from said control unit, said signal receiver means causes said power source to be disconnected from said sensor and said alarm, and concurrently energizing of said timer.
